(19) United States
(12) Patent Application Publication
(10) Pub. No.: US 2015/0090715 A1
(43) Pub. Date: Apr. 2, 2015

(54) End cap with identification card

(71) Applicant: Norman Quagliani, Warren, MI (US)

(72) Inventor: Norman Quagliani, Warren, MI (US)

(21) Appl. No.: 13/998,118

(22) Filed: Oct. 2, 2013

(51) Int. Cl. F16L 55/11

(52) U.S. Cl. CPC F16L 55/11
USPC 220/212

(57) ABSTRACT

The disclosure relates to an end cap device for easily identifying a pipeline system. The device is interchangeable among and between pipeline systems. The device is further advantageous in that it is designed to easily fit onto various pipeline, hose line, or pipeline termination banks. The device comprises a housing, and various attachment mechanisms for an interchangeable identification card. The housing includes a top surface, an outer lateral surface, an inner lateral surface and a bottom portion. The identification card includes matching holes to align with the various attachment mechanisms. The identification card is adaptable to visually display identification information about a pipeline system.

### TECHNICAL FIELD

This disclosure relates generally to certain pipeline and hose equipment known as dust caps or end caps used in hose lines, pipelines, and pipeline termination racks. More specifically, this disclosure relates to a dust cap or end cap utilized for the quick identification of the contents of the pipeline system when adding or removing fluids from or to hose lines or pipelines.

### BACKGROUND

A wide variety of pipe end caps have been developed in the art. These end caps primarily include screw-type fittings, cam and groove type fittings, and dry-break fittings. The cam and groove type connectors are very popular among conventional pipe equipment used in the mining industry, the petroleum industry, the marine industry, irrigation systems, water treatment works, and power generation facilities. The cam and groove type pipe fittings are designed to easily connect pipelines or any other tubular conduits like hose lines. End caps are designed to prevent the leakage of liquids or gas with their tight connection at the end of hoses and pipes.

All pipe and hose end caps are designed to prevent fluid leakage, primarily liquid leakage. To prevent leakage or seepage, the end points of pipelines and the hose lines must be tightly sealed. Several methods have been developed for the prevention of leakage at the end of pipes and hose line terminations. End caps have also been employed simply as a protective safety cover. For example, U.S. Pat. No. 5,687,772 issued to Underwood describes a protective end cap for covering the ends of exposed bars and, in particular but not limited to, a protective end cap for covering the ends of starter bars on construction sites.

Some end caps have been designed to incorporate a “quick release” type feature. U.S. Pat. No. 6,568,430 issued. to Shafer describes quick-release pipe end caps for use in connection with pipes. The quick release pipe end caps have a cap that covers the end of a pipeline and a quick release mechanism that removably secures the cap to the pipeline without requiring the use of other pipefitting tools.

However, one shortcoming identified with conventional end caps is that they do not provide a means to identify the content of the pipelines. Quick identification of the content of the pipelines is required for filling or removing fluids from a pipeline. It is especially critical when all the end connections are situated in a common bank of multiple pipeline terminations all fitted with end caps. Identification of the contents of the pipeline are important to prevent opening the wrong pipeline to either fill or remove liquid product from the pipeline. There have few attempts to make the identification of the contents of a pipeline easier.

U.S. Pat. No. 7,644,734 issued to Palmer describes a male and female safety cap to protect the hands of the operator. The male safety cap has a circular disk with a diameter larger than the female fitting and a loop handle. The female safety cap has raised parallel ridges to protect the cam arm and a loop handle. The loop handle forms a continuous arcuate structure to provide protection to the operator's hand. The safety caps are shown to be color coded or affixed with labels designed to fit within the handle. However, this particular end cap design requires a handle that is integral to the end cap in order to affix the product label.

The end cap devices referenced above provide some desirable features and benefits within the limited scope of their designs. Each has certain benefits and drawbacks, as well, with respect to the fact that they are not effective to identify the contents of a pipeline system or hose line.

Based on the foregoing, it is desirable to have an end cap that provides liquid leak protection and can be easily applied to identify pipelines or pipeline system contents. This type of end cap would also be available in different sizes, different materials, and different features thereby allowing it to easily fit with any pipeline, hose line, or pipeline termination bank. Finally, this end cap would also be of a simple design that incorporates the invention disclosed herein.

### SUMMARY

Disclosed herein is an end cap that addresses the abovementioned shortcomings with the current end cap devices, especially with respect to the inability to identify the contents of the pipeline. Heretofore, there has not been an end cap for quickly identifying the contents of a pipeline system, hose line, or multiple terminations in a bank of pipeline terminations, while at the same time protecting the pipeline system from fluid leakage and cross-contamination (ie, contamination caused by putting a fluid into a pipeline that is incompatible with the other fluid contents contained in that pipeline).

The disclosure herein is directed to an end cap designed for quick identification of the contents of hose lines or liquid transport systems while either filling or removing fluids from or to those systems. When several end connections are situated in a common bank of hose line terminations fitted with end caps, it would relatively easy to fill or empty the wrong system when there is no identification of the pipeline that the operator is connecting to for performing the fill or empty operation. There is also disclosed a unique method for providing identification of a pipeline system by applying an identification card into a an end cap that has been designed and fabricated to receive such identification card. Because the identification card is removable, the card can be removed and a new card inserted when the end cap is to be used on a different pipeline.

While the various embodiments of the disclosure are described with reference to a device for identifying the contents of a pipeline system quickly using an end cap with an identification feature, it is to be understood that there may be combinations of equipment and other methods that could be used to identify the pipeline system. There is no device or apparatus or method with the disclosed features for use in pipeline systems. Other applications and advantages of such an end cap will become immediately obvious to one skilled in the art. It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### DESCRIPTION OF THE DRAWINGS

FIG. 1A is a top view of one embodiment of an end cap of the present invention.

FIG. 1B is an exploded view of one embodiment of the end cap of the present invention.

FIG. 1C is a perspective view of one embodiment of the end cap of the present invention.

FIG. 1D is another perspective view of one embodiment of the end cap of the present invention.

FIG. 1E is a side view of one embodiment of the end cap of the present invention.

FIG. 2A is a top view of another embodiment of the end cap of the present invention.

FIG. 2B is a side view of another embodiment of the end cap of the present invention.

FIG. 3A is a top view of another embodiment of the end cap of the present invention.

FIG. 3B is a side view of another embodiment of the end cap of the present invention.

### DESCRIPTION

What is being disclosed is an end cap fabricated and designed to provide identification information of hose and pipeline system contents. Other objects, advantages and applications will be best understood and become apparent from the following description of the various embodiments when read in connection with the accompanying drawings.

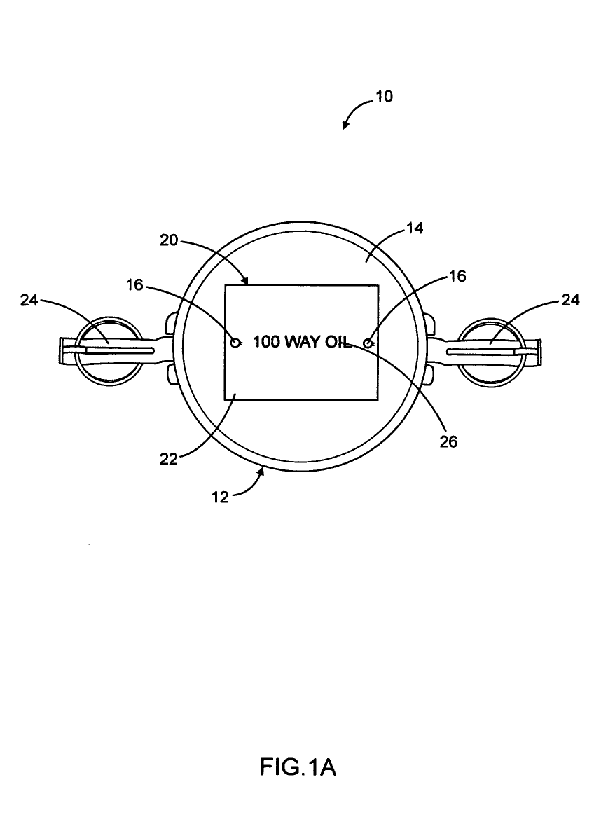

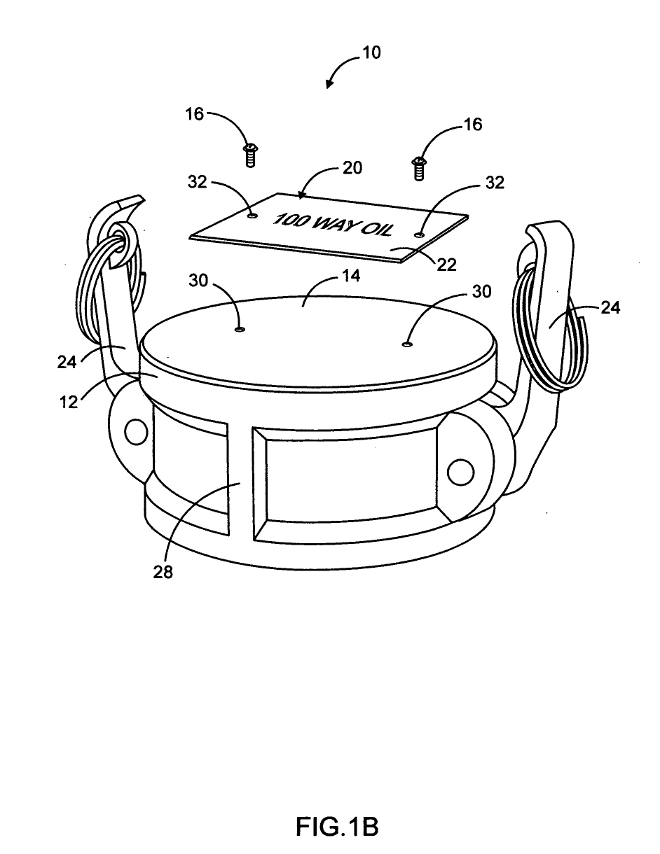

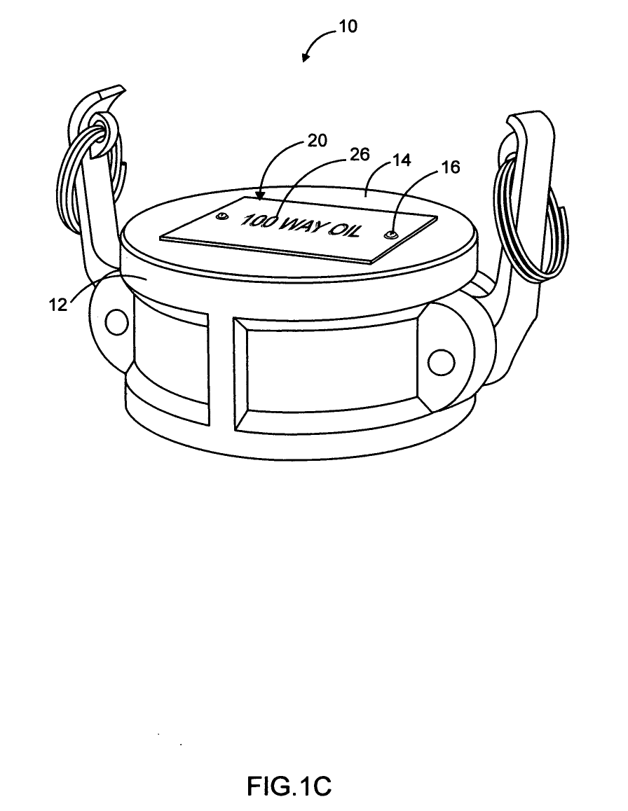

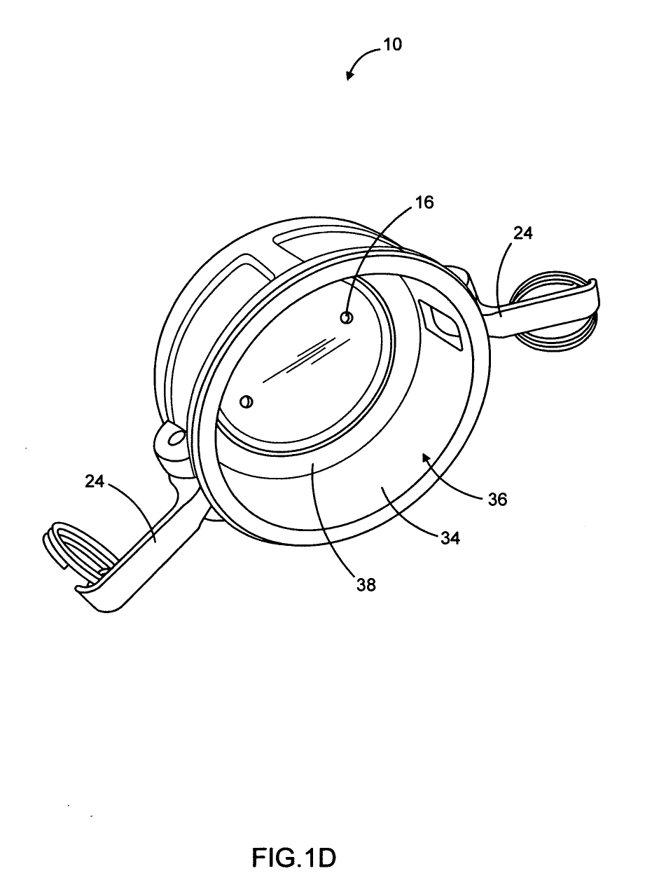

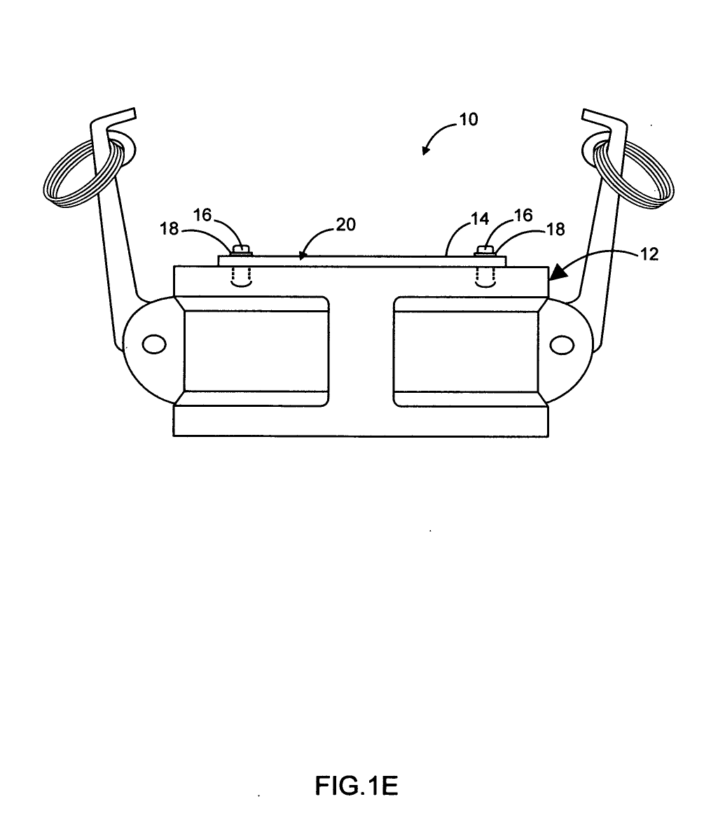

Referring to FIGS. 1A and 1B, the end cap 10 for a pipeline system is shown here in the preferred embodiment of the invention. The end cap 10 is designed for quickly visually identifying contents of hose lines prior to filling or removing liquids from a pipeline system. In the preferred embodiment, the end cap 10 comprises a housing 12, a plurality of studs 16 and an identification card 20. The end cap 10 allows quick, visual identification of the contents of hose lines or liquid transport systems while either filling or removing fluids from or to those systems when an identification card 20 is properly inserted into the top surface 14 of the housing 12.

As shown in FIG. 1D, the housing 12 comprises a top surface 14 and a bottom portion 36 (FIG. 1D). The bottom portion 36 is designed to releasably connect to the hose lines, couplings and, liquid transport fittings employing a cam and groove type engagement mechanism. The housing 12 is preferably cylindrical in shape.

As shown in FIG. 1B, the top surface 14 comprises a plurality of stud connecting holes 30. A plurality of studs 16 is designed to be suitably connected to the top surface 14 by engaging the plurality of stud connecting holes 30. The identification card 20 includes an upper surface 22 and a plurality of matching holes 32 positioned at the upper surface 22. The identification card 20 is removably attachable to the top surface 14 of the housing 12 by engaging the plurality of studs 16 with the plurality of matching holes 32.

As shown in FIG. 1D, the housing 12 further comprises an outer lateral surface 28 and an inner lateral surface 34. In the preferred embodiment, the outer lateral surface 28 includes a pair of locking arms 24. Each of the pair of locking arms 24 is opposite to each other. The pair of locking arms 24 allows the end cap 10 to securely engage with the pipeline system that has a complementary matching male end connection (not shown) utilizing the cam and groove type connecting mechanism. The bottom portion 36 is designed to releasably connect to a receiving end portion of a hose and/or a pipe (not shown).

With reference to FIG. 1C, a perspective view of the preferred embodiment of the end cap 10 is illustrated. The identification card 20 is adaptable to display identification information 26 of the pipeline system. Referring to FIG. 1D again, a perspective view of the preferred embodiment of the end cap 10 showing the inner lateral surface 34 of the end cap 10 is illustrated. The inner lateral surface 34 includes a gasket 38. The gasket 38 allows the male end portion of a hose and/or a pipe to tightly fit with the inner lateral surface 34.

As shown in FIG. 1E, a side view of the preferred embodiment of the end cap 10 is illustrated. The plurality of studs 16 engage with the top surface 14. Each of the plurality of studs includes a securing element 18. The securing element 18 may be a machined groove to accept an external snap ring fastener (not shown), a through hole near the top of each of the plurality of studs to accept a cotter pin (not shown), or a threaded rod to accept a complimentary threaded nut (not shown), or a screw that can be inserted into a connecting hole 30 that is tapped to receive a screw connecting mechanism. The securing element 18 allows the identification card 20 to be releasably attached to the top surface 14 of the end cap 10.

In use, the plurality of studs 16 is engaged with the plurality of stud connecting holes 30. The plurality of matching holes 32 positioned at the upper surface 22 of the identification card 20 is engaged with the plurality of studs 16. Then the identification card 20 is positioned on the top surface 14 of the housing 12 by engagement with the plurality of studs 16 and the securing element 18. The information 26 on the identification card 20 enables quick identification of the pipelines and hoses attached to the end cap 10.

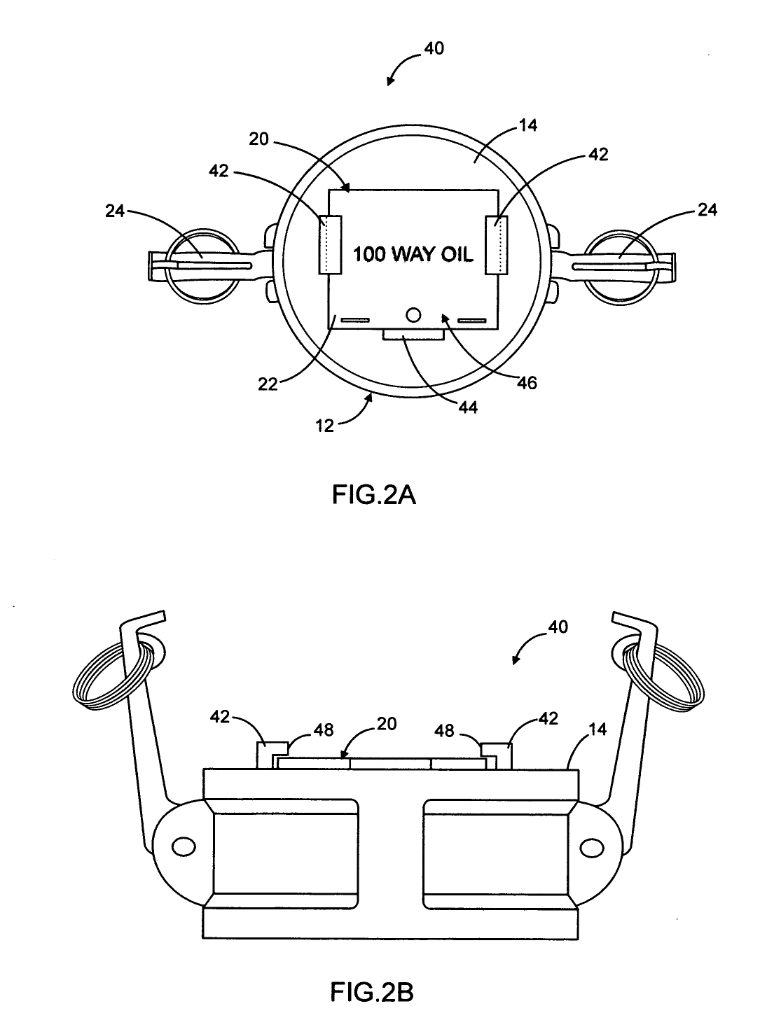

In another embodiment, and with reference to FIGS. 2A and 2B, an end cap 40 comprises a plurality of angle bosses 42 located on the top surface 14. Each of the plurality of angle bosses 42 includes a lip portion 48 that allows an identification card 20 to securely attach between the plurality of angle bosses 42. The plurality of angle bosses 42 are fixedly attached to the housing 12 utilizing any suitable attachment mechanism. The attachment of the angle bosses 42 to the top surface 14 may be achieved by casting, welding, or adhesive bonding depending on the material of the housing 12. In this embodiment, the identification card 20 includes a leading edge to facilitate easy placement of the identification card 20 under the plurality of angle bosses 42. The identification card 20 possesses an appropriate size, shape and thickness to securely fit between the plurality of angle bosses 42 and below the lip portion 48. The end cap 40 further comprises a raised stop boss 44 that is intended to prevent the identification card from inadvertently falling through the angle bosses 42. The raised stop boss 44 engages a bottom portion 46 of the identification card 20.

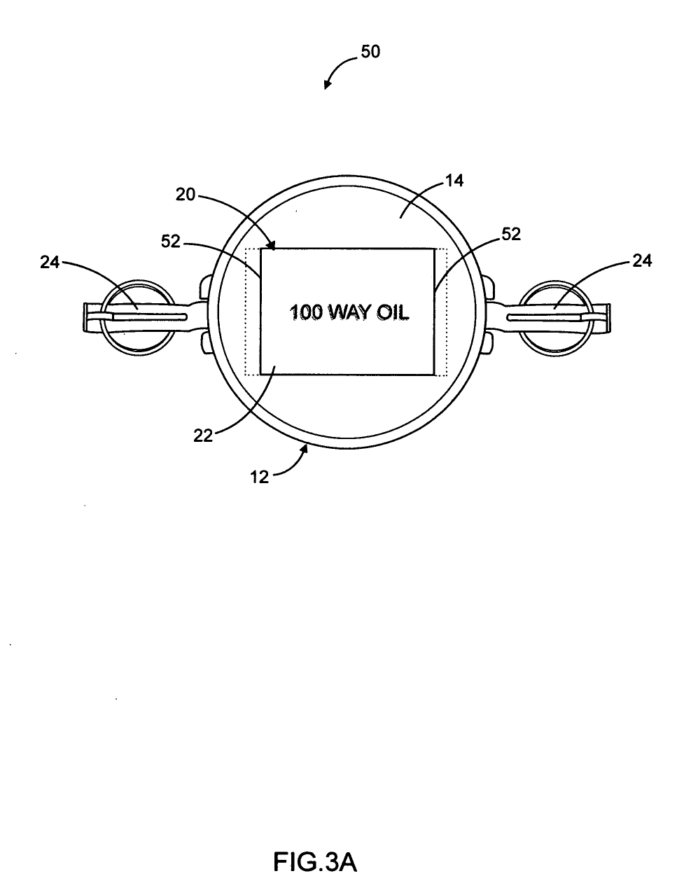

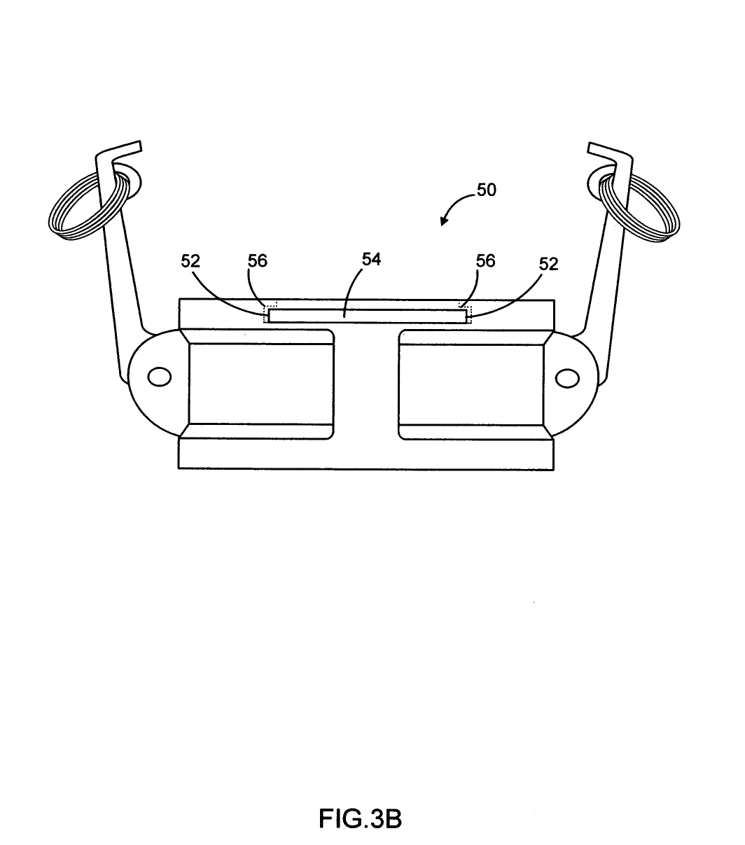

In yet another embodiment, and with reference to FIGS. 3A and 3B, an end cap 50 comprises a cavity area 54 and an identification card 20 with a pair of opposing sides 52. The cavity area 54 includes at least two retaining lips 56. The at least two retaining lips 56 allow the identification card 20 to be retained inside the cavity area 54.

With reference to FIG. 3B, the cavity area 54 is formed by casting or machining an appropriate area of the top surface 14 and attaching the opposing and overlapping retaining lips 56 utilizing any appropriate attaching mechanism, such as casting, welding, or adhesive bonding.

Referring specifically to FIG. 3B, there is shown the identification card 20 with the pair of opposing sides 52 inserted beneath the at least two retaining lips 56 located within the cavity area 54. The at least two retaining lips 56 require the identification card 20 to be slightly flexed in order to position the pair of opposing sides 52 between the at least two retaining lips 56. The pair of opposing sides 52 extend under the at least two retaining lips 56. The identification card 20 is thereby releasably attached to the top surface 14 of the end cap 10.

The foregoing descriptions provide illustration of the inventive concepts. It should be understood that the foregoing is illustrative of particular embodiments of the invention, and particular applications thereof. The descriptions are not intended to be exhaustive or to limit the disclosed invention to the precise form disclosed. Modifications or variations are also possible in light of the above teachings. In view of the disclosures presented herein, yet other variations of the invention being disclosed will be apparent to one of skill in the art. The embodiments described above were chosen to provide the best application to thereby enable one of ordinary skill in the art to utilize the invention in various embodiments and with various modifications as are suited to the particular use contemplated. All such modifications and variations are within the scope of the invention. Any such modifications or variations which fall within the purview of the descriptions contained herein are intended to be included therein, as well. It is the following claims, including all equivalents, which define the scope of the invention.

What is claimed is:

1. An end cap, comprising:
a housing, the housing being generally cylindrical and further comprising a top surface, an outer lateral surface, an inner lateral surface and a bottom portion;
an identification card holder means located on the top surface, the identification card holder means comprising one of a plurality of angle bosses, a plurality of studs, or a cavity area; and
an identification card, the identification card adaptable to engage the identification card holder means.

2. An end cap, comprising:
a housing, the housing comprising a top surface, an outer lateral surface, an inner lateral surface and a bottom portion, the top surface comprising a plurality of stud connecting holes;
a plurality of studs, the plurality of studs designed to engage the plurality of stud connecting holes, each of the plurality of studs comprising a securing element; and
an identification card, the identification card comprising an upper surface adaptable to display identification information and a plurality of matching holes located on the upper surface.

3. The end cap of claim 2 wherein the securing element comprises a releasably attachable means for attaching the identification card to the plurality of studs.

4. The end cap of claim 2 wherein the housing is generally cylindrical.

5. The end cap of claim 2 wherein the inner lateral surface comprises a cam and groove type engagement mechanism.

6. The end cap of claim 2 wherein the plurality of studs is attached to the stud connecting holes utilizing any suitable attachment mechanism.

7. The end cap of claim 6 wherein the attachment mechanism is selected from a group consisting of casting, welding, screwing, and adhesive bonding.

8. The end cap of claim 3 wherein the securing element comprises a threaded connection.

9. An end cap, comprising:
a housing, the housing comprising a top surface, an outer lateral surface, an inner lateral surface and a bottom portion, the top surface comprising a plurality of stud connecting holes;
a plurality of studs, the plurality of studs designed to engage the top surface through the plurality of stud connecting holes, each of the plurality of studs comprising a securing element; and
an identification card, the identification card comprising an upper surface adaptable to display identification information of the pipeline system and a plurality of matching holes at the upper surface, the identification card removably attachable to the top surface of the housing by engaging the plurality of matching holes with the plurality of studs, wherein the plurality of studs comprises a securing element, the securing element comprising a threaded connection.

10. A method for identifying a pipeline system utilizing an end cap with an identification card, the method comprising the steps of:
providing a housing having a top surface, an outer lateral surface, an inner lateral surface, a bottom portion and a plurality of stud connecting holes;
providing a plurality of studs designed to engage the plurality of stud connecting holes, wherein each stud has a securing element;
providing an identification card having an upper surface and a plurality of matching holes;
engaging the plurality of studs with the matching holes to position the identification card;
utilizing the securing element to attach the identification card to the top surface of the housing; and
attaching the housing with the identification card to an end of a pipeline system to identify the pipeline system.

11. The method of claim 10 wherein the securing element comprises a threaded connection.

12. The method of claim 10 wherein the housing is generally cylindrical.

13. The method of claim 10 wherein the housing further comprises a cam and groove type engagement mechanism.

14. The method of claim 10 wherein the pipeline system comprises hose lines, couplings, liquid transport fittings, and pipeline termination racks that employ the cam and groove type engagement mechanism.
